(19) United States
(12) Patent Application Publication
(10) Pub. No.: US 2007/0245230 A1
(43) Pub. Date: Oct. 18, 2007

(54) Method, system, and computer-readable medium to uniformly render document annotations across multiple computer platforms

(76) Inventor: Aleksey G. Cherkasov, Covington, GA (US)

Correspondence Address: McIntyre Harbin & King, 500 Ninth Street SE, Washington, DC, 20003, US

(21) Appl. No.: 11/783,911

(22) Filed: Apr. 13, 2007

Related U.S. Application Data
(60) Provisional application No. 60/792,315, filed on Apr. 14, 2006.

(51) Int. Cl. G06F 17/00

(52) U.S. Cl. 715/512; 715/530; 715/531; 715/500

(57) ABSTRACT

A computer-implemented method, system, and computer-readable medium to uniformly display electronic annotations of a document across differing computer platforms of an imaging system where documents are stored as images on an image file server. An exemplary method comprises a user producing a textual representation of a document annotation, generating an image and associated attributes (e.g., size, location, color, etc.) of the annotation, storing the annotation image in a record of an annotation file, and accessing the annotation file record to retrieve the annotation image in a standard universal format whereby to render a combined image representation of the document overlaid with the annotation image according to the attributes. Standard formats include jpeg, gif, tiff, or Windows metafile. Instead of storing the annotation image in the record, a pointer may be stored in the record to enable retrieval of the annotation image from another memory location.

### CROSS-REFERENCE TO RELATED PATENTS AND PATENT APPLICATIONS

This invention claims the benefit of Provisional Application Ser. No. 60/792,315 entitled “Document Management System, Method, and Computer-Readable Medium o Effect Implementation Thereof,” filed Apr. 14, 2006, which application in its entirety is incorporated by reference herein.

### BACKGROUND

This invention relates to an imaging system, but more specifically, to a method, system, and a computer-readable medium to effect uniform display or rendering of document annotations across a variety of computer platforms.

To assist in work-flow processing of files, documents, records, or images of an imaging system, it is convenient to add annotations, pictures, hyperlinks, or multimedia content to an existing document file. This permits the user to mark relevant portions and annotate documents with electronic “sticky” notes, highlights, arrows, markers, free-form text and other graphical marks so that the user's work group may conveniently assess information contained in the document. Electronic annotations may also include redaction capabilities for censoring sensitive documents. Annotations are frequently used in medical records annotation systems (e.g., to mark x-rays in preparation for surgery), document or file management systems (e.g., to aid work flow processing of documents), and perhaps in word processing applications where a mark or note is made temporarily or permanently to a primary document image under examination.

Generally, electronic annotations are stored in a separate file (called an “annotation file”) and are overlaid over the document's text or image file when subsequently displayed or rendered on a computer monitor. This way, the original document is not directly altered. Optionally, the annotations may be “burned-in” the document file, that is, permanently overlaid or written onto the document so that it becomes a permanent part of the file of the original document. Under the permanent alteration option, once annotations are burned-in, the original document becomes altered and annotations become a permanent part of the file.

Prior systems, including those commercially available from Accusoft, Adobe and PixelTranslation, have at least one common drawback in providing annotations; i.e., some of the annotations may not preserve their appearance from one machine to another, e.g., across different computer platforms. This is because different computer platforms often vary in operating system, configuration, font types, and/or display/rendering applications. In a majority of cases, this problem was found to be related to machine setup, such as fonts that are missing or that differ from the annotations when originally authored on a another computer. In some cases, the appearance of annotations was so dramatic that the annotations either were read improperly or were completely unreadable.

ImageGear includes the AccuSoft Redlining Toolkit™ (ART), which is believed to be the standard for annotation technology in document or file management systems. The ART component provides the ability to annotate image and document files with electronic “sticky” note attachments, highlights, arrows, markers, free-form text and other indicators. It also includes redaction capabilities for censoring sensitive documents.

Hummingbird ImageBASIC provides an image annotation engine that may read and write Eastman/Wang® annotations, read and convert Watermark® annotations and, read Pixel Translations® annotations. Hummingbird's annotations are layered and preserved in groups so that they can be integrated within a security system and displayed only to authorized users. Annotations may also be stored in the header data of a tiff file, or in a separate database. In either case, the file may be sent or displayed with or without annotations.

Snowbound is another commercially available annotation package which is described at http://www.snowbound.com/flexsnap_webtop/webtop_annotations.html.

The foregoing systems and methods, however, may have difficulty in uniformly displaying or rendering annotations across different computer platforms. The present invention, on the other hand, seeks to solve this and other problems by providing a consistent or uniform representation of annotations across computers having differing platforms.

### SUMMARY OF THE INVENTION

In accordance with the present invention, there is provided a computer-implemented method of uniformly rendering electronic annotations of a document file across differing computer platforms, which may serve many different types of networked computers. The method comprises producing an annotation for a document file, generating an image of the annotation, storing the document file and associated annotation image in a memory, and accessing the memory to obtain the document file and associated annotation image in order to render an image representation of the document file overlaid with said annotation image. The document file may also comprise an image stored in an image file server and the accessing step may include rendering on a display device a combined image of the document and annotation image. In addition, the annotation image may be stored as a field in a record of an annotation file along with attributes stored in other fields of the record. Instead of storing the annotation image in the record, a pointer may be stored the record to enable retrieval of the annotation image from another memory location. Standard image formats, e.g., jpeg, gif, tiff, and Windows metafile, may be used for the annotation image and/or the document file.

Another aspect of the invention comprises a computer-implemented method of uniformly rendering annotations for a document stored in memory across differently configured computer systems. In this embodiment, the method comprises producing an annotation for said document; generating attributes for the annotation; using a standard image format to generate an annotation image of the annotation produced in the producing step; storing the annotation image and attributes in an annotation file; and accessing the document and annotation file in order to retrieve and render on a display device a combined visual representation of the document and annotation image according to the attributes. Attributes may identify such properties as the size, color, or location of the annotation.

Another aspect of the invention comprises a computer-implemented system that provides uniform rendering of a document file and an associated annotation thereof across different computer platforms. Such embodiment comprises a processor to enable a user to obtain a document file, to generate an annotation associated with the document file, and to generate an annotation image indicative of a visual appearance of the annotation; a memory to store the document file and associated annotation image generated by the processor; and a rendering device, e.g., a graphical user interface of a client device, that accesses the memory to obtain the document file and associated annotation image in order to uniformly render said document file overlaid with said annotation image. Similar to the corresponding method embodiment, the system may employ records of an annotation file to store the annotation image or attributes thereof, or a pointer to the annotation image if its size does not permit containment within a record field. The document file and/or the annotation image/attributes may also be stored on a common or separate file or image server of a network.

Another aspect of the present invention comprises a system to uniformly render a visual representation of a document and an associated annotation thereof across differently configured data processing devices. Such a system comprises a processor that enables a user to produce an annotation, associated attributes thereof, and an annotation image that visually depicts said annotation; a memory to store the document, annotation image, and associated attributes; and a rendering device that accesses the memory to obtain and uniformly render the document and associated annotation image on a graphical user interface according to the attributes. The memory may comprise a networked file or image server.

According to yet another aspect of the present invention, there is provided a computer-readable medium to store executable program instructions to effect operation of a computer-implemented imaging system to enable a user to produce an annotation for a document file stored in memory; to generate an image and associated attributes of the annotation produced by the user; to store the image and associated attributes in a memory; and in response to a request by the same or a subsequent user, to access the memory to obtain the document file and associated annotation image in order to render a combined visual representation of the document file and annotation image according to the attributes. The computer-readable medium may effect computer-implementation of other methods disclosed herein.

Other aspects, features, and embodiments will become apparent upon review of the following detailed description taken in connection with the accompanying drawings. The invention, though, is pointed out by the appended claims.

### BRIEF DESCRIPTION OF THE DRAWINGS

FIG. 1 depicts a document image having an overlaid note.

FIG. 2 shows an annotation file having multiple records or marks that each characterizes the attributes of an overlaid annotation.

FIG. 3 is a flow diagram illustrating a method according to an aspect of the present invention.

FIG. 4 shows a system-implementation of the invention.

### DESCRIPTION OF ILLUSTRATIVE EMBODIMENT

### Glossary of Terms

Annotation file—a file or block of memory (buffer) that stores information about annotation appearances and rendering rules.

Annotation mark—a record in an annotation file that describes the appearance and rendering properties of a particular annotation mark. An annotation mark may include information about the font type used for an annotation (see “Font Information”).

Font—Typeface or a coordinated set of designs for characters, or a computer file that stores such designs (See, for example, http://en.wikipedia.org/wiki/Font for details).

Font Information—information describing a type face that includes font family, size, and style (etc.) of the font used for the annotation, which may be part of an annotation mark record.

Windows® Metafile—Windows Metafile (WMF) is a graphic file format of1 Microsoft Windows systems originally designed in the early 1990s. It is a vector-based graphic format that also allows the inclusion of raster graphics. Essentially, a WMF file stores a list of function calls that may be issued to the Windows graphics layer GDI in order to restore the image.

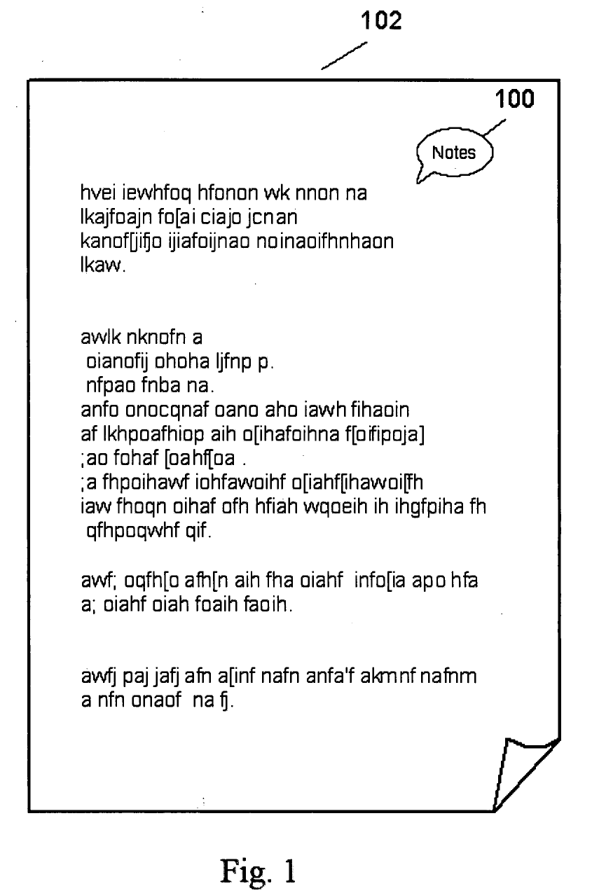

In a document or records manage system where documents are stored as image files, FIG. 1 illustrates an annotation 100, e.g., a callout note, generated by an author and placed on a document image 102 at a particular position (in this case, to draw attention to the first paragraph of the document image). Document 102 may comprise a document of a file management system, a record of a medical management system, or a file of any other type of imaging system that displays or renders a file or image. The annotation may comprise other forms of annotation, such as an image, a highlighted section of the document, underlining, etc. When the author applies the annotation (using a computer “mouse” or keyboard), information associated with the annotation 100 (e.g., location of the annotation on the document, appearance, or other information) is written into an annotation file associated with document 102. Each annotation placed on the document image 102 has an associated record in the annotation file, called an annotation mark record.

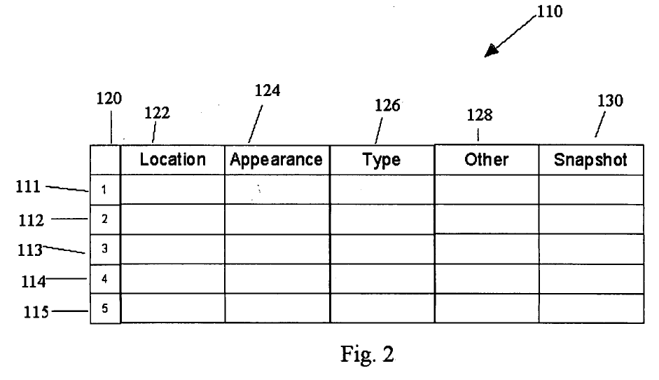

FIG. 2 illustrates an exemplary annotation file 110 having multiple records 111, 112, 113, 114, and 115 that characterize the attributes of an annotation mark. There are as many annotation mark records in the file 110 as there are annotations applied by users to the document image.

Each annotation record contains attributes of the annotation mark in a number of fields that embody information about location of annotation mark's, mark appearance (colors, line size and shape), and other information desired by the developer or system administrator. A first field 120 identifies a record number attribute, a second field 122 contains information relating to the location of the annotation on the document image 102 (FIG. 1), a third field 124 contains information relating to the appearance attribute of the annotation, a fourth field 126 identifies the font type attribute for the annotation, and a fifth field 128 contains other attributes about the annotation (e.g., text, audio, etc.). Some annotations (such as “sticky” notes and stamps) may also contain font information that is used to render the appropriate font face on a hardware device (such as computer monitor or printer).

When the annotation file 110 is subsequently accessed by a different computer, the type font identified in field 126 may not been previously installed on the computer. In this case, attempts to render the font type will fail. The rendering computer's operating system, however, will often attempt to substitute the type font of field 126 with the closest font available within its operating database to visually match the font type. If no match is found, the rendering computer will typically substitute a default system font, whereupon an error is likely introduced into the appearance of annotation due to the missing font or imperfect font matching routine applied by the operating system of the rendering computer. As mentioned above, the appearance problem may dramatically impact usability of the annotations.

To resolve this problem, the present invention provides a way to preserve annotation appearance across different computers. This is achieved in the authoring computer system. Instead of providing “text” to represent the annotation, the annotation mark record is used to create a standard “image” format of the annotation. This image basically is a visual “snapshot” of the annotation and captures the appearance of the annotation as the authoring user sees it. When the annotation file is used on another computer, the displaying computer system renders the snapshot image in its standard image format (e.g., jpeg, gif, windows metafile, tiff, etc.), instead of entering a routine to reproduce the font or “text” annotation identified by field 126 of the annotation mark record. By “snapshot” it is meant to create an image file of the annotation.

An exemplary way to implement the invention is to provide another field 130 (FIG. 2) in the annotation record that contains an image annotation file. Thus, the records or marks in the annotation file would include an image file that displays the visual appearance of the annotation in a standard image format, e.g., GIF, JPEG, WMF, BMP, etc. Since the annotation mark is typically small and does not require a large amount of storage, the image file may conveniently fit into the annotation record. Large annotation marks, if needed, may be stored in a separate file that is linked with the record, e.g., field 130 may comprise a pointer to the larger image file. The annotation image thus generated would then be overlaid on the original document image 102, or burned into the original document image, if desired.

If a user subsequently decides to modify the annotation 100 (FIG. 1), another visual snapshot may be taken to capture the new appearance of the modified annotation, and the modified snapshot may replace the previous annotation image. The old annotation mark may still be used to render the annotation while the user is modifying it and may still be persisted with the mark in the annotation file.

Advantageously, the image of the annotation will not change when rendered to a device of another computer since a computer, regardless of the platform implemented or configuration thereof, will recreate the same image pixel-by-pixel, using the standard image file format.

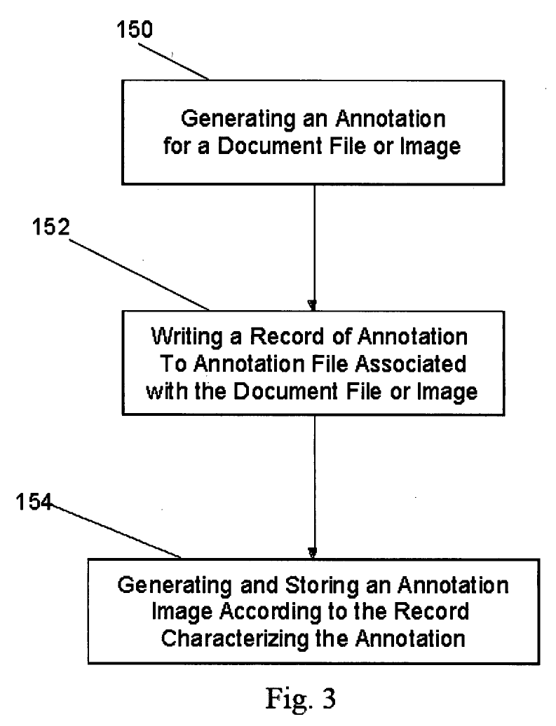

FIG. 3 illustrates a method according to an aspect of the present invention. The method comprises step 150 of generating an annotation for a document file or image, step 152 of writing a record of annotation to an annotation file associated with the document file or image to characterize the annotation, and step 154 of generating and storing an annotation image according to the record characterizing the annotation. Step 154 may also comprise storing the annotation image in the record, or alternatively, storing the annotation image in a separate file and storing a pointer to the separate file of the annotation image in the record.

While this invention is not specific to any particular image format, it should be noted that some formats are better suited than others. For instance, it is general knowledge that certain formats are device-dependent and others are device-independent. For use with the present invention, device-independent image formats are more preferable in annotation authoring system because of the their ability to be rendered in a consistent manner on different devices.

Another consideration concerns rasterized vs. vectored image formats. A vector-based image format is more preferable because the annotation image will not lose quality while being scaled up and down in size. As such, an annotation image format such as “Windows® Metafile” has been found to be more appropriate than others. In a current implementation, it has been found that an EMF image format (“Enhanced Windows® Metafile”) provided very compact image file storage and was vector-based, which makes it a good candidate for use with the present invention where the annotation image is stored in the annotation record.

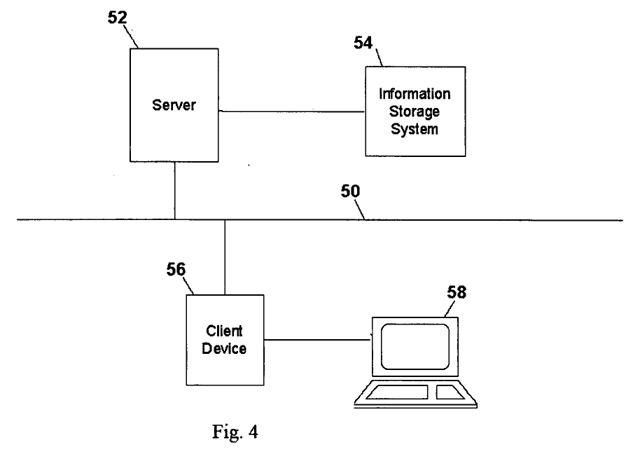

FIG. 4 shows an exemplary system to uniformly render or display a visual representation of a document and associated annotation(s) thereof on a workstation, comprising client device 58 and display monitor 58 that communicate over network 50 with a file management server 52 and file storage system 54. In a multi-user environment, network 50 typically serves multiple workstations whose client devices are often configured differently for their unique fonts and/or associated display, rendering, or printing devices. Because of these different configurations, textual annotations created at one workstation may not be identically reproduced at another workstation. The present invention, however, solves this problem by using an image “snapshot” of the annotation(s), which is most likely transparent to the operating system or configuration of the respective workstations.

To advantageously provide uniform rendering of annotations across different computer platforms, workstation 56, 58 (or the central server 52 if processing is centrally controlled) includes a processor that enables a user to retrieve a file from local storage of device 56 or from network storage system 54 (e.g., an image server) on network 50 in order to produce an annotation using a conventional text editor or word processing of a document annotator. The user also specifies associated attributes for the annotation to identify the location, size, color, or other attributes of the annotation(s) relative to the document retrieved from memory. After creating the annotation, processor of device 56 (or server 52) generates an annotation image (i.e., snapshot) of the textual annotation to visually depict the annotation using a standard image format, such as jpeg, tiff, gif, or a Windows metafile. Other formats may also be used. The annotation image is then stored in a memory for subsequent access by the same or other users, who may also communicate over network 50.

In one embodiment, the annotation image and associated attributes are stored in a record of an annotation file residing on network storage system 54 where the annotation file includes multiple records each identifying an annotation of a document file stored on network storage device 54 (or stored on a local device of a workstation). A single document file, which may also be stored as an image file, may have multiple annotations. The original document file, however, is maintained in storage device 54 in an unaltered form.

When an “annotated” document is subsequently accessed in response to a user request originating at workstation 58 (or at another workstation communicating over network 50), server 52 responds by retrieving the document file from central storage 54 and also by retrieving the document's associated annotations from corresponding records of the annotation file (which may also be stored on storage device 54). This information is then transmitted to the user over network 50 so that the user's workstation 56, 58 may uniformly render the document file and associated annotation images on graphical user interface 58 according to retrieved attributes. The local processor of device 56 assembles in a conventional way the document image and the annotation image so that both are overlaid on display device 58.

Generally, the system illustrated in FIG. 4 may be programmed to carry out any of the methods disclosed herein.

Based on the teachings herein, the illustrated embodiments may be altered without departing from the scope of invention. Thus, it is the intent to include within the scope of the present invention all such modifications and variations as may come to those skilled in the art based on the teachings herein.

I claim:

1. A computer-implemented method of uniformly rendering electronic annotations of a document file across differing computer platforms, said method comprising:
producing an annotation for a document file,
generating an image of the annotation,
storing in a memory the document file and associated image of said annotation, and
accessing the memory to obtain the document file and associated annotation image in order to render an image representation of the document file overlaid with said annotation image.

2. The method of claim 1, wherein said document file comprises an image and said accessing step include rendering on a display device a combined image of said document file and annotation image.

3. The method of claim 2, wherein said storing step comprises storing the annotation image in a record of an annotation file along with attributes of said document file, and said rendering step comprises accessing the record to retrieve and render said combined image of said document file and annotation image.

4. The method of claim 2, wherein said storing step comprises storing a pointer for the annotation image in a record of an annotation file, and said rendering step comprises accessing said record to retrieve said pointer in order to retrieve and render said combined image of said document file and annotation image.

5. The method of claim 3, wherein said generating step includes generating said annotation image in one of a jpeg, gif, tiff, and Windows metafile format.

6. The method of claim 4, wherein said generating step includes generating said annotation image in one of a jpeg, gif, tiff, and Windows metafile format.

7. A computer-implemented method of uniformly rendering annotations for a document stored in memory across differently configured computer systems, said method comprising:
producing an annotation for said document;
generating attributes for said annotation;
using a standard image format, generating an annotation image of the annotation produced in the producing step;
storing the annotation image and attributes in an annotation file; and
accessing the document and annotation file in order to retrieve and render on a display device a combined visual representation of the document and annotation image according to said attributes.

8. The method of claim 7, wherein said storing step comprises storing the annotation image and attributes in a record of said annotation file and said accessing step includes accessing said record to retrieve the annotation image and annotation attributes.

9. The method of claim 8, wherein said standard image format comprises one of a jpeg, gif, tiff, and Windows metafile format.

10. A computer-implemented document management system that provides uniform rendering of a document file and an associated annotation thereof across different computer platforms, said system comprising:
a processor to enable a user to obtain a document file, to generate an annotation associated with the document file, and to generate an annotation image indicative of a visual appearance of said annotation;
a memory to store the document file and associated annotation image generated by said processor; and
a rendering device that accesses said memory to obtain the document file and associated annotation image in order to uniformly render said document file overlaid with said annotation image.

11. The document management system of claim 10, wherein said memory includes an annotation file having at least one record to store said annotation image and attributes thereof, and said processor access said record in order to retrieve and render a combined visual representation of the document file and annotation image according to said attributes.

12. The document management system of claim 11, wherein the annotation image is created in one of a jpeg, gif, tiff, and Windows metafile format.

13. A system to uniformly render a visual representation of a document and an associated annotation thereof across differently configured data processing devices, said system comprising:
a processor that enables a user to produce an annotation, associated attributes thereof, and an annotation image that visually depicts said annotation;
a memory to store said document, annotation image, and associated attributes; and
a rendering device that accesses the memory to obtain and uniformly render the document and associated annotation image on a graphical user interface according to said attributes.

14. The system according to claim 13, wherein said attributes specify the location and size of the annotation relative to said document.

15. The system of claim 14, wherein said memory includes a record of an annotation file to store the annotation image and said attributes and said rendering device obtains the annotation image and attributes from said record to render the document.

16. The system of claim 15, wherein said memory includes an image server to store an image representation of said document, and said rendering device obtains the document from said image server to render a combined visual representation of said document and annotation image.

17. The system of claim 16, wherein said record stores said annotation image in a standard image format comprising one of a jpeg, gif, tiff, and Windows metafile format.

18. A computer-readable medium to store executable program instructions to effect operation of a computer-implemented imaging system to enable a user to produce an annotation for a document file stored in memory; to generate an image and associated attributes of the annotation produced by said user; to store the image and associated attributes in memory; and in response to a request by a user, to access the memory to obtain the document file and associated annotation image in order to render a combined visual representation of the document file and annotation image according to said attributes.

19. The computer-readable medium of claim 18, wherein said memory includes an image file server that stores said document file, and said program instructions effect accessing and retrieval of said document file from said image file server to render said combined visual representation.

20. The computer-readable medium of claim 19, wherein said memory includes a record of an annotation file that stores said annotation image and associated attributes, and said program instructions effect accessing and retrieval of said annotation image and associated attributes from said record in order to render said combined visual representation.
